(19) United States
(12) Patent Application Publication
(10) Pub. No.: US 2013/0262704 A1
(43) Pub. Date: Oct. 3, 2013

(54) SYSTEM AND METHOD FOR IMPROVING DELIVERY OF CONTENT OVER A NETWORK

(71) Applicant: Arvind Jain, Los Altos, CA (US)

(72) Inventor: Arvind Jain, Los Altos, CA (US)

(73) Assignee: GOOGLE INC., Mountain View, CA (US)

(21) Appl. No.: 13/438,488

(22) Filed: Apr. 3, 2012

(51) Int. Cl. G06F 15/16

(52) U.S. Cl. 709/247

(57) ABSTRACT

A system and method provide for improving delivery of content over a network, such as a wireless network. Copies of previously loaded content may be stored locally on a client computing device coupled to the network. Future requests for similar content may be compressed based on the locally stored previously loaded content, and the compressed content may be delivered to the client device. The client device may use the stored previously loaded content to reconstruct the requested content.

### BACKGROUND

Loading content through a network, such as loading an Internet web page, can be very slow on any computing device, including desktop computers. Loading such content may be even slower on mobile computing devices, such as mobile phones, and when using wireless network connections, such as 3G. For example, many 3G networks have become congested due to increasing mobile web usage. Moreover, many users of computing devices frequently load the same content. For example, a user may visit a particular web site every day or multiple times per day. Accordingly, much of the congestion is caused by transmission of repetitive data.

While current compression techniques exist for reducing amounts of data transmitted over a network, these techniques may sacrifice a quality of the content being delivered. For example, Bytemobile currently has a product which reduces 3G bandwidth consumption for videos. However, this product downgrades the video content in order to achieve reduced bandwidth consumption.

### SUMMARY

A system and method provide for improved delivery of content over a network, and in particular over a wireless network. Because users of network computing devices, such as mobile phones, often request content with some degree of regularity (e.g., accessing a web site every day), copies of previously loaded content may be stored locally, such as on the mobile device. Accordingly, upon future requests for similar content (e.g., the same web site at a future date, or a different page of the same web site), only differences between the future similar content and the locally stored previously loaded content may be delivered to the device. For example, the future similar content may be compressed using GNU zip (“gzip”), where a gzip dictionary is seeded using the locally stored previously loaded content. The device may then use the stored previously loaded content to reconstruct (e.g., decompress or “gunzip”) the requested content. In this regard, bandwidth and/or data usage may be reduced, while still providing all desired content to a client device. Thus, content may be delivered at faster speeds while reducing congestion on the network.

One aspect provides a method of retrieving requested content. The method may comprise determining whether copies of similar content are locally available, and if copies of similar content are locally available, transmitting a request for the content, wherein the request identifies the locally available similar content. The method may further comprise receiving a compressed file associated with the requested content, and decompressing, using a processor, the compressed file using the locally available similar content.

Another aspect provides a device for retrieving requested content. The device may include a processor and a memory in communication with the processor. The memory may store one or more files of previously downloaded content, identifiers associated with each of the one or more files of previously downloaded content, and instructions executable by the processor for downloading requested content according to a method. This method may comprise determining whether copies of similar content are locally available, if copies of similar content are locally available, transmitting a request for the content, wherein the request identifies the locally available similar content, receiving a compressed file associated with the requested content, and decompressing the compressed file using the locally available similar content.

A further aspect provides a method for serving data over a network. This method may comprise receiving a request for content, and determining whether the request includes an identifier associated with the content. If the request includes an identifier associated with the content, the requested content may be retrieved and compressed using a processor and files corresponding to the identifier. For example, the retrieved content may be compressed using gzip, where a gzip dictionary is seeded using the files corresponding to the identifier. The compressed content may be transmitted, for example, to a client device.

Yet another aspect provides a device for serving data over a network, comprising a processor, a compression unit, and a memory in communication with the processor and the compression unit. The memory may store files corresponding to previously retrieved content, identifiers associated with the files, and instructions executable by the processor for performing a method. This method may comprise receiving a request for content, the request including a requested content identifier associated with the content, retrieving the requested content, compressing, at the compression unit, the requested content using files corresponding to the requested content identifier, and transmitting the compressed content.

### BRIEF DESCRIPTION OF THE DRAWINGS

FIG. 1 illustrates a system according to some aspects of the disclosure.

FIG. 2 illustrates an example of content delivered over a network, according to some aspects of the disclosure.

FIG. 3 illustrates an example of an updated version of the content of FIG. 2.

FIG. 4 illustrates a device for serving data over a network, according to some aspects of the disclosure.

FIG. 5 illustrates an example communication flow for the system of FIG. 1.

FIG. 6 illustrates a method for serving content according to some aspects of the disclosure.

FIG. 7 illustrates another method for serving content, according to some aspects of the disclosure.

### DETAILED DESCRIPTION

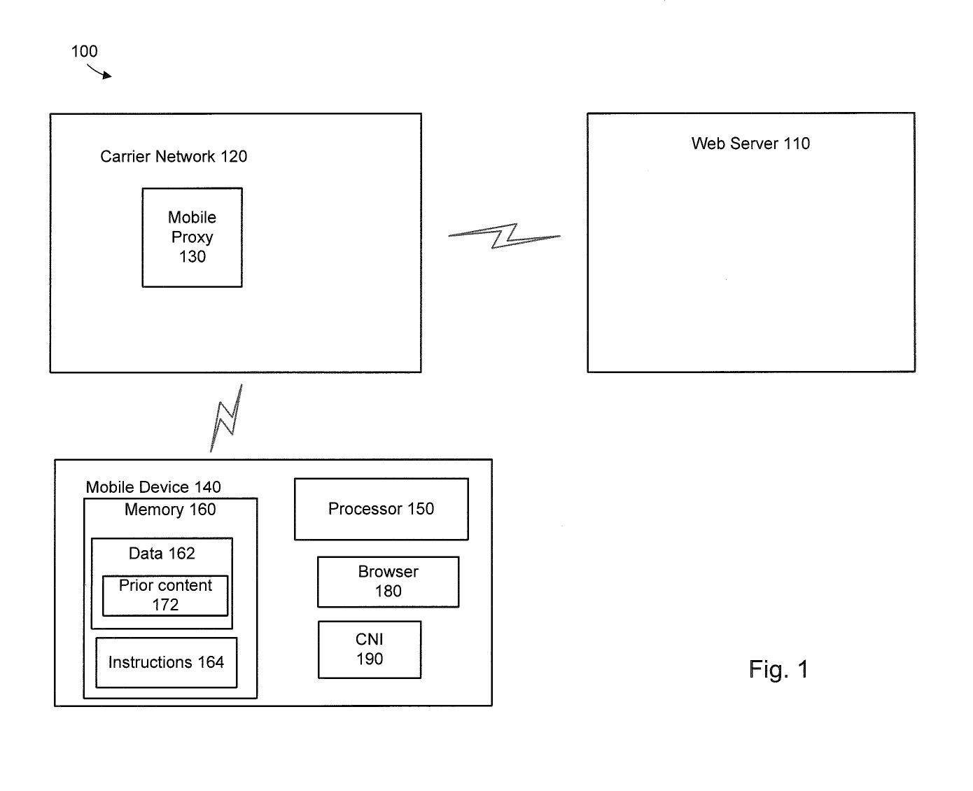

FIG. 1 illustrates a system 100 according to one aspect of the disclosure. According to this system, a mobile device 140 communicates with a server, such as web server 110, through carrier network 150. For example, the mobile device 140 may request content, such as a website, from the web server 110 through carrier network 120. If the mobile device 140 requests the same content periodically, much of that content may remain unchanged. For example, if a user visits a same web page every day, the web page may appear very similar from one day to the next. Accordingly, the static content need not be re-downloaded. Rather, a copy of the content last downloaded may be stored, and only the differences in the content between the last download and a current download may be delivered to the mobile device 140.

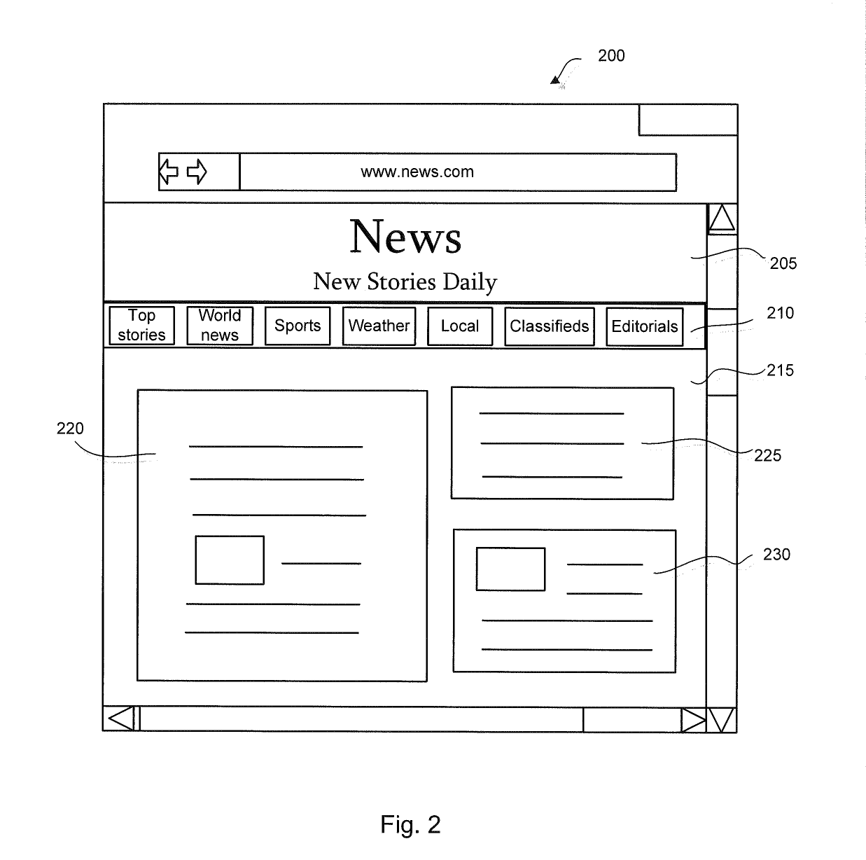

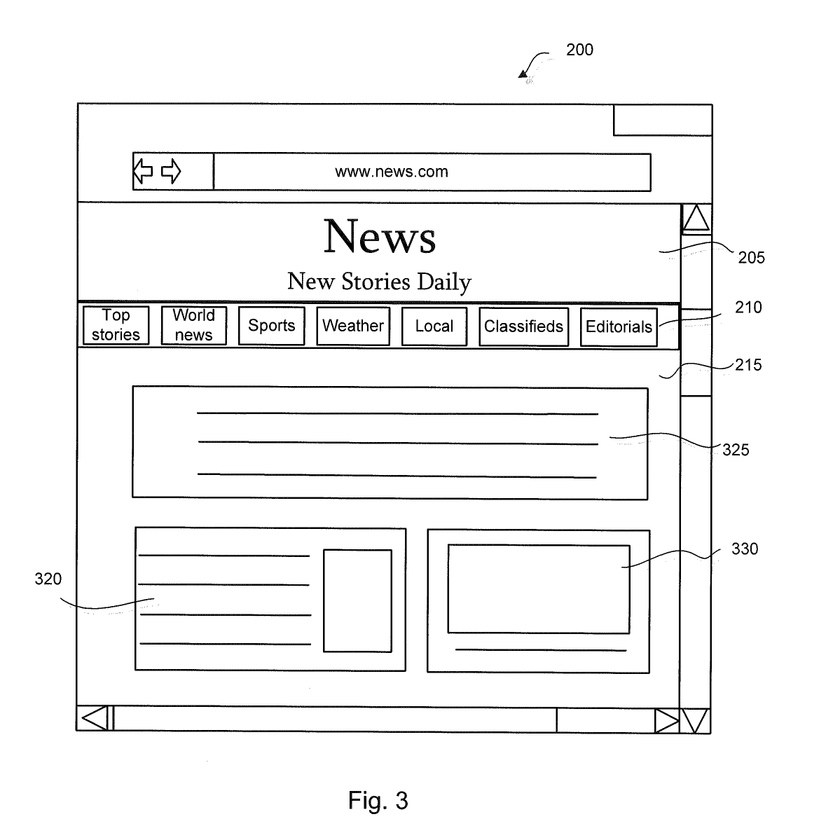

For example, referring to FIGS. 2-3, FIG. 2 illustrates an example of a webpage 200 at a first time (e.g., Day 1), and FIG. 3 illustrates an example of the same web page 200 at a second time (e.g., Day 2). The webpage 200 may include a banner 205, page selection buttons 210, and background 215. These features may be relatively static, for example, and may generally not vary from day to day. However, the webpage may also include first content portions 220, 225, 230 (shown in FIG. 2), and second content portions 320, 325, 330 (shown in FIG. 3), which may vary periodically (e.g., hourly, daily, weekly, etc.). If a user visits the webpage 200 frequently, the static portions (banner 205, page selection buttons 210, background 215) may not need to be downloaded each time. Rather, a copy of the webpage 200 at the first time may be stored, and only differences (e.g., second content portions 320-330) may need to be downloaded upon a subsequent visit to the webpage.

Referring back to FIG. 1, the mobile device 140 may comprise any device capable of communication over a network. For example, the device 140 may be a mobile phone, tablet PC, laptop, netbook, video game console, mp3 player, handheld computer, digital camera, television set-top box, in-car navigation device, or the like. According to some aspects, the device 140 need not be mobile at all, but may rather be, for example, a desktop computer communicating with server 110 through a wired or wireless Internet connection.

In some implementations, the mobile device 140 includes a browser 180 and a client network interceptor (CNI) 190. The browser may be any application used to download content over a network, such as Chrome, Safari, Firefox, Internet Explorer, e-mail applications, or content-specific applications, such as apps for stocks, weather, maps, real estate, social networks, blogs, etc.

The CNI 190 may be, for example, a software module or a separate hardware device in communication with or integrated with the mobile device 140. The CNI 190 may communicate with the browser 180, for example, to deliver requested content. According to some aspects, the CNI 190 maintains a database of content that has been previously delivered to the browser 180. According to other aspects, such a database is maintained by the browser.

As shown in FIG. 1, the mobile device 140 further comprises a processor 150 in communication with a memory 160. Memory 160 of mobile device 140 stores information accessible by processor 150, including instructions 164 that may be executed by the processor 150. Memory also includes data 162 that may be retrieved, manipulated or stored by the processor, such as copies of previously downloaded content. The memory may be of any type capable of storing information accessible by the processor, such as a hard-drive, memory card, ROM, RAM, DVD, CD-ROM, write-capable, and read-only memories. The processor 150 may be any well-known processor, such as commercially available CPUs. Alternatively, the processor may be a dedicated controller such as an ASIC.

The instructions 164 may be any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data 162 may be retrieved, stored or modified by processor 150 in accordance with the instructions 164. For instance, although the system and method is not limited by any particular data structure, the data may be stored in computer registers, in a relational database as a table having a plurality of different fields and records, or XML documents. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information that is used by a function to calculate the relevant data.

Although FIG. 1 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

The carrier network 120 may be any network providing a data connection between a computing device and a server. For example, the carrier network 120 may be a wireless service provider network, such as Verizon, AT&T, or Sprint. Alternatively, the network 120 may be any type of network including a variety of configurations and protocols, and may be used to connect a computing device (wired or wirelessly) to a server. For example, the network may include the World Wide Web, intranets, virtual private networks, wide area networks, local networks, private networks using communication protocols proprietary to one or more companies, Ethernet, WiFi (such as 802.11, 802.11b, g, n, or other such standards), and HTTP, and various combinations of the foregoing. Such communication may be facilitated by any device capable of transmitting data to and from other computers, such as modems (e.g., dial-up, cable or fiber optic) and wireless interfaces.

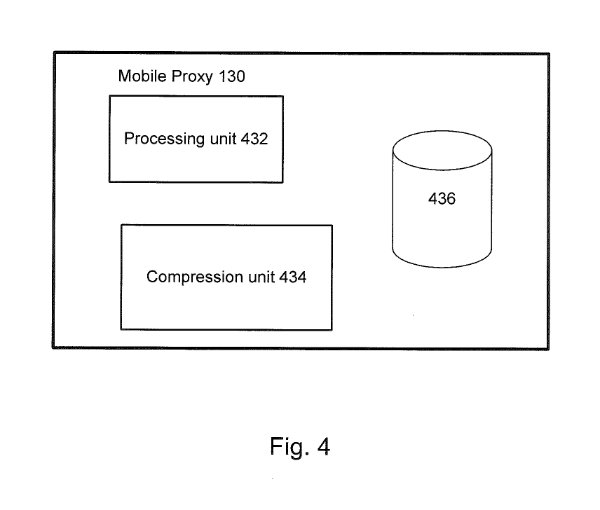

The carrier network 120 may include a mobile proxy 130. The mobile proxy 130 may intercept traffic between the mobile device 140 and the web server 110, and may facilitate downloading of only differential content. The interception of traffic may be transparent to a user. A more detailed illustration of the mobile proxy is provided in FIG. 4.

As shown in FIG. 4, the mobile proxy 130 may include a processing unit 432 in communication with a memory 436 and a compression unit 434. The processor 432 may be any type of processor, similar to the processor 150 of the mobile device 140 described above. Moreover, the memory 426 may similarly include data and instructions for facilitating the download of differential content.

The compression unit 434 may be a software module executable by the processor 432 or a separate processing component. The compression unit 434 may utilize a compression technique, such as GNU zip (gzip), deduplication, Unix Compress, Shared Dictionary Compression over HTTP (SDCH), in order to reduce received content. For example, as discussed in further detail below, the mobile proxy 130 may receive an indication from the CNI 190 that a previously downloaded version of requested content is cached at the client device. Accordingly, the compression unit 434 may extract data from the received content where that data also exists in the previously downloaded version.

The web server 110 may be configured similarly to the mobile device 140, with a processor, memory, instructions, and data. While the server 110 is described as a web server, which may be used for serving content over the Internet, it should be understood that the server 110 may be any type of network server. For example, the server 110 may serve content over a local area network, virtual private network, or any other network of computing devices. The server may be a personal computer, intended for use by a person, having all the internal components normally found in a personal computer such as a central processing unit (CPU), display device (for example, a monitor having a screen, a projector, a touch-screen, a small LCD screen, a television, or another device such as an electrical device that is operable to display information processed by the processor), CD-ROM, hard-drive, user input (for example, a mouse, keyboard, touch-screen or microphone), speakers, modem and/or network interface device (telephone, cable or otherwise) and all of the components used for connecting these elements to one another. Moreover, computers in accordance with the systems and methods described herein may comprise any device capable of processing instructions and transmitting data to and from humans and other computers including general purpose computers, PDAs, network computers lacking local storage capability, set-top boxes for televisions, and other networked devices.

Although only a single mobile device 140 is shown in FIG. 1, it should be appreciated that a large number of computers may communicate with the mobile proxy 130.

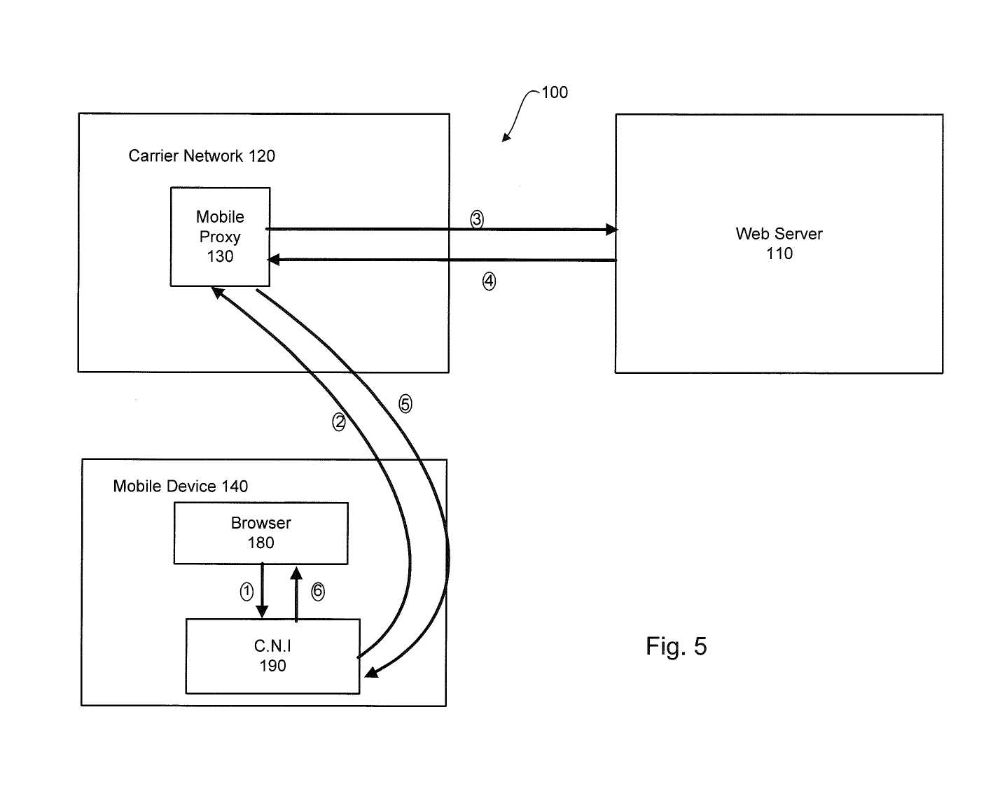

FIG. 5 illustrates an example of a communication flow over the system 100. It should be understood that such communications are merely by way of example, and that additional or fewer components may be invoked in the communications while still providing differential data and therefore increasing communication speeds. Moreover, while the communications are described in a particular order, it should be understood that the sequence of some communications may be varied.

A user of the mobile device 140 requests a web page from the server 110. This request originates at the browser 180 (e.g., where the user enters a given URL) and passes through CNI 190 and the mobile proxy 130 to the server 110. A response to the user's request may follow a reverse path.

In one implementation, mobile proxy 130 attaches a unique identifier to each file served from the server to the client. The CNI 190 maintains, in its memory or in a memory elsewhere on the mobile device 140 accessible by the CNI 190, a listing of content that is received by the browser. For example, the CNI 190 memory may store the identifiers of the files that were assigned by the mobile proxy 130. A copy of the content may also be stored at the browser, at the CNI 190, or in another location accessible by the mobile device 140 in association with its identifier. According to some aspects, a given identifier may be maintained temporarily (e.g., for one week, one month, several months, until additional space is needed, until a predetermined number of other identifiers have been stored since the given identifier was last accessed, etc.).

On a new request for new content from the client 140 to the server 110, the CNI 190 looks for stored files similar to the new content. For example, the CNI 190 may look for all files (or the N most recent files) that are present in its cache corresponding to a domain which matches a domain of the new content. The mobile proxy 130 also stores copies of these files in association with the identifiers. The CNI 190 attaches the identifiers corresponding to the located files to the new request, which it sends to the server 110. In some instances, multiple matches between the stored files and the new content may be found. For example, if the new request is for www.news.com/topstory!=2, stored files corresponding to www.news.com/topstory!=5, www.news.com/obituaries, and www.cnn.com may be located. According to some aspects, the CNI 190 may select which files to identify in sending the new request for the server. For example, the selection may be based on a closest matching URL, a timestamp, or any other information associated with the files. Alternatively, the CNI 190 may send the identifiers corresponding to all of the multiple matches along with the new request.

The new request may be intercepted by the mobile proxy 130, which may in turn request files corresponding to the new content from the server. Upon receiving a response including the files corresponding to the new content from the server 110, the mobile proxy 130 may compress the response using the copies of the stored similar files. In performing such compression, the mobile proxy 130 may compare the new content to the stored similar files, and extract redundancies from the new content. For example, referring back to FIGS. 2-3, where FIG. 3 is the new content and FIG. 2 is the stored file, the banner 205, page selection buttons 210, and background 215 may be extracted from the new content of FIG. 3, since those features are the same as in the stored file of FIG. 2. This compression may be performed using, for example, gzip. Gzip is a string compression algorithm, which builds a dictionary of strings as it receives data to compress. When new data is received, gzip runs a substring matching algorithm to compare the new data with strings present in its dictionary. If there is a match, the new data is encoded as a reference to that match, thereby using fewer bytes to encode the data. Accordingly, to perform the compression of the new content using gzip, the mobile proxy 130 may first prime the internal gzip dictionary with the content from the stored files corresponding to the identifiers received in the request. For example, the dictionary may be built using the old content from the stored files. Once the gzip dictionary has been seeded or set up in this fashion, the mobile proxy 130 will now hand over the new file to the gzip compressor for compression. For example, as the new content is passed to gzip, strings for the new content are matched with those present in the dictionary built so far. If there are matches, the new data is encoded as references to those matches. Since large parts of the new content may already be present in the primed gzip dictionary, which includes strings for the older stored files, a compression algorithm used by the gzip compressor will be able to compress the new file by representing the content of the new file as references to similar content present in its dictionary.

Referring to the instance where the CNI 190 sends identifiers corresponding to multiple matches with the new request, the mobile proxy 130 may determine which identifiers to use in the gzip compression. For example, this determination may be based on timestamps, URLs, or any other data associated with the files. According to some implementations, the compressed response is further compressed using known compression techniques.

The compressed response may be sent to the client 140. All the IDs loaded into the gzip dictionary may also be sent to the client 140.

The CNI 190 receives the compressed response from the mobile proxy 130, and uses the stored files to reconstruct the requested content. For example, where the mobile proxy 130 uses gzip compression to compress the delivered content, the CNI 190 may look at the IDs loaded into the gzip dictionary, and may prime a gzip decompressor with the stored files corresponding to those IDs. The CNI 190 may therefore decompress (e.g., using gunzip) the response from the mobile proxy 130, thereby generating the requested new content for delivery to the browser 180.

Although the mobile proxy 130 is described above as residing in the carrier network 120, it should be understood that according to alternative aspects, the mobile proxy 130 may reside on the web server 110, or other server associated with the web server 110. For example, the web server 110 may be capable of compressing requested content based on information provided by the mobile device 140, and may provide this compressed content directly to the mobile device 140.

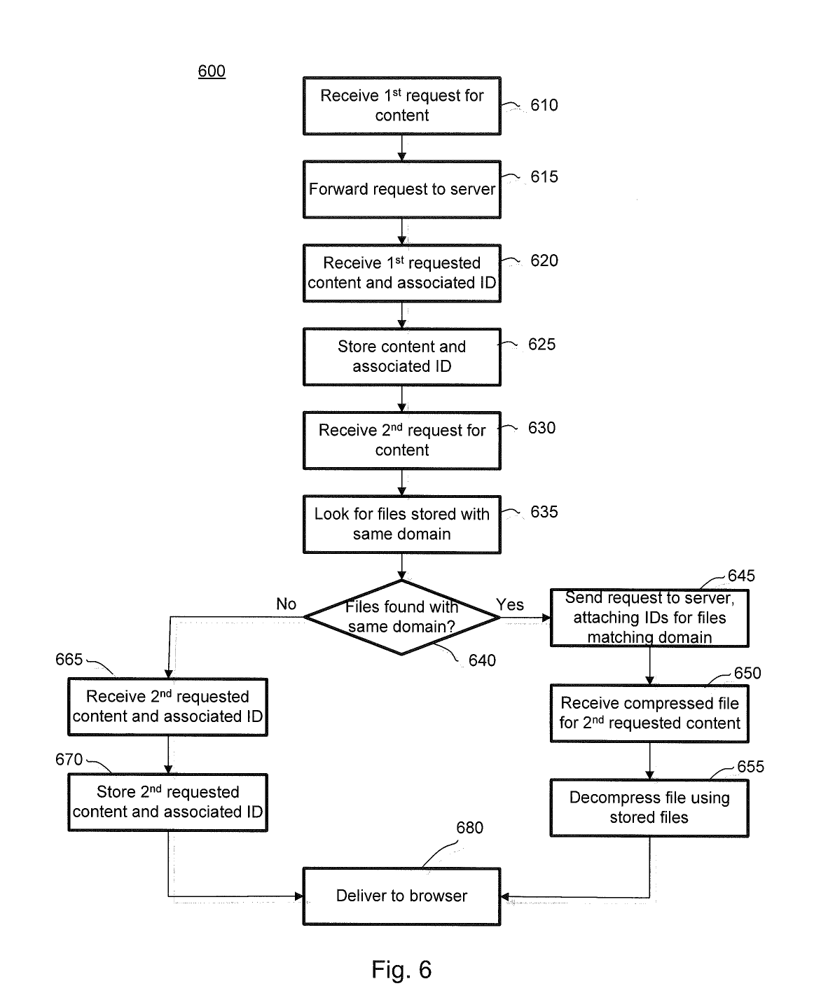

FIG. 6 illustrates a method 600 of serving content. The method may be performed, for example, by the CNI 190 in communication with the mobile device 140. While various stages of the method are illustrated and described in a particular order, it should be understood that these stages do not have to be performed in this order. Rather, various stages may be handled in a different order or simultaneously, and stages may also be added or omitted unless otherwise stated.

In block 610, a first request for content is received. The requested content is, for example, a particular page of a website. According to this example, the request may be generated by typing a URL into a browser, clicking a hyperlink, selecting a “bookmarked” page from browser history, or any other mechanism for accessing a web page.

In block 615, the request is forwarded to a server. For example, where the requested content is a web page, the server may be an Internet server or a site-specific server. According to some examples, the request may be indirectly forwarded to the server through another device, such as the mobile proxy 130.

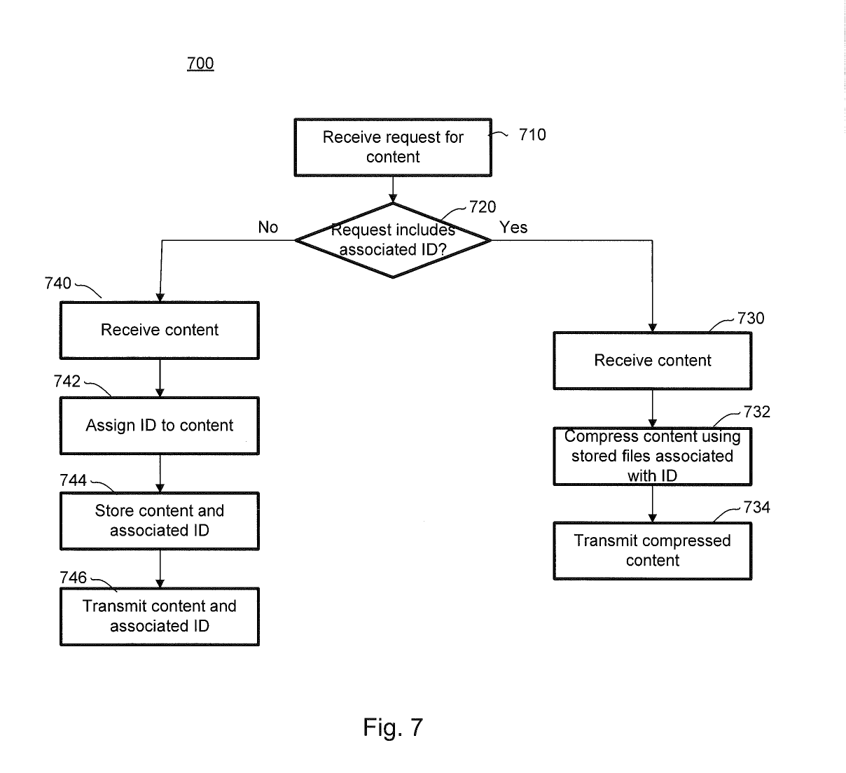

One or more files corresponding to the first requested content may be received along with an associated identifier at block 620. For example, the mobile proxy 130 may assign an identifier to the each file before transmitting it to the CNI 190, as discussed in further detail with respect to FIG. 7.

The CNI 190 stores the received files and associated identifiers at block 625. For example, the CNI 190 may maintain a cache of all recently received files and identifiers. The files and the associated identifiers may be stored using any of a number of techniques, such as a lookup table. For example, one entry in the lookup table may include an Internet Protocol (IP) address for a received web page, while a corresponding entry in the table include the associated identifier. However, it should be understood that any of a number of techniques for storing an object in association with another may be used. According to some examples, the received files and associated identifiers may only be stored for a predetermined period of time, such as one week, one month, etc., or until space for storing additional files and identifiers is needed.

In block 630, a second request for content may be received. Similar to block 610, the request may be for any type of data served over a network, such as a web page. The second request for content may be received at any time in relation to the first request, such as immediately after, the next hour, the next day, the next week, etc.

In block 635, the CNI 190 may look for files previously stored which are similar to the second requested content. For example, the CNI 190 may look for files having the same server IP address, the same domain, the same top level domain, or the exact same URL. According to one aspect, if the second requested content was a web page at the address www.news.com/topstory, the CNI 190 may search its memory for addresses including, for example, www.news.com/topstory, www.news.com/topstory?=2, editorials.news.com, www.news.com/localnews, etc.

According to some aspects, each content (e.g., web page) may be comprised of a plurality of files. In block 640, it may be determined whether files similar to the second requested content are found.

If similar files are found in block 640, a request for the second content may be sent to the server along with the identifiers for the similar files (block 645). Similar to block 615, the second request may be indirectly transmitted to the server, for example, through the mobile proxy 130.

In block 650, a compressed file including the second requested content may be received. The file may be compressed in the sense that it includes a reduced amount of data. For example, the compressed file may only include differences or updates in the second requested content as compared to the files located having the same domain. Referring back to the examples of FIGS. 2-3, if files for www.news.com are located and include the contents shown in FIG. 2, and if the second requested content corresponds to the webpage 200 shown in FIG. 3, the compressed file received may include second content portions 320, 325, 330, and not the banner 205, page selection buttons 210, and background 215.

In block 655, the compressed file may be decompressed using the stored files corresponding to the identifiers sent in block 645. For example, the second requested content may be reconstructed using data already cached at the CNI 190. Referring back to the examples of FIGS. 2-3, where the compressed file includes the second content portions 320-330, data from the webpage 200 of FIG. 2 (which is stored) may be used to provide the banner 205, page selection buttons 210, and background 215 to reconstruct the webpage of FIG. 3. This reconstructed webpage may then be delivered to the browser 180 (block 680).

If it is determined in block 640 that no files are located that are similar to the second requested content, the second requested content and an associated identifier may be received at block 665. Similar to block 620, the second requested content may be received in its entirety, because there may not be any stored data usable to compress or decompress the content. Accordingly, the second requested content and associated identifier may be stored at block 670 (e.g., for a potential match to future requested content), and the content may be delivered to the browser 180 at block 680.

According to some aspects, the compressed file received in block 650 may also be received with an assigned identifier corresponding to the second content. Accordingly, the second content may be stored with its associated identifier for potential future use (e.g., matching future requested content). In this regard, if the user again requests similar content, the content may be compressed/decompressed based on the most recently accessed version. Accordingly, the client and mobile proxy 130 may keep their databases up to date.

FIG. 7 illustrates a method 700 of serving content. The method may be performed, for example, by the mobile proxy 130 of the carrier network 120.

In block 710, a request for content is received. For example, this request may be from a client device (e.g., a mobile or desktop computing device), or from a CNI 190 coupled thereto. The requested content may be, for example, a webpage, a picture file (e.g., jpeg, bmp, gif), a video file (e.g. mpeg, wmv), a music file, an application (“app”) or particular data associated with an app, or any other content.

In block 720, it may be determined whether the received request includes an identifier associated with previous or similar versions of the requested content. For example, if the requested content is a web page, the identifier may indicate to the mobile proxy 130 that the computing device or CNI 190 issuing the request already stores a copy of a previously downloaded version of the web page, or a copy of another web page having the same domain. Regardless of whether the received request includes an identifier, the request may be forwarded to a server and the mobile proxy 130 may receive the requested content in return (blocks 730, 740). However, depending on whether the request from the client device includes an identifier, the received content may be handled differently.

If the request includes an identifier, the received content may be compressed at block 732 using the stored content associated with the received identifier. For example, the mobile proxy 130 stores the same copies as the CNI 190 of the previously downloaded or similar content, and maintains those copies in a database in association with their respective identifiers. Thus, when a received request for updated content points to one of those identifiers, the mobile proxy 130 compresses the updated content using the copies of previously downloaded or similar content. The mobile proxy 130 may use a compression technique, such as gzip. According to this example, the mobile proxy 130 may load the previous/similar copies into a gzip dictionary, which may then remove redundancies between the previous/similar copies and the current content from the current content. The gzip compression may result in creating a compressed file including only the differences or updated content as compared to the previously downloaded content. This compressed file may be transmitted (e.g., to the CNI 190 or requesting computing device) in block 734.

If it is determined in block 720 that the received request does not include an associated identifier, it may be assumed that at least the requesting device does not include a copy of previously downloaded content corresponding to the request. According to some aspects, the mobile proxy 130 may also not include such copies in its database. However, because the mobile proxy 130 may communicate with a number of client devices, it may include such copies. Regardless, the method 700 may proceed to block 740, where the requested content is received (e.g., from the server 110).

In block 742, an identifier may be assigned to the received content. For example, this identifier may be used for future downloads of similar content (e.g., requests for the same webpage at a future date). According to one aspect, the identifiers assigned to particular content may be consistent, regardless of which client device requests the content.

In block 744, the content and the assigned identifier may be stored. For example, the mobile proxy 130 may maintain a database of all received content in association with the assigned identifiers (e.g., organized in a lookup table). The content and the assigned identifier may be transmitted, for example, to the client device and/or CNI 190, in block 746.

Although the methods of FIGS. 6-7 have been described above as enabling compression of a same web page as previously downloaded or a similar page from a same web site as previously understood, it should be understood that the same concepts may be applied to an expanded set of data. For example, according to one aspect, sites having different domains (e.g., www.cnn.com and www.foxnews.com) may include overlapping content. For example, these sites may include a similar format, the same photographs, the same classifieds, or the like. This overlap may be recognized by, for example, the CNI 190 and/or the mobile proxy 130. Accordingly, where a user first retrieves and caches a web page from cnn.com, and then requests content from foxnews.com, the content from foxnews.com which overlaps with the content from cnn.com may be extracted prior to transmission of the content over the network.

Moreover, while the systems and methods described have mainly been described with reference to a mobile phone/data network, such as 3G, it should be understood that the concepts described may be applied to any network. For example, the compression techniques may be used for desktop computers retrieving content from servers over a local area network. Similarly, the compression techniques may be implemented in a wide area network, virtual local area network, world-wide web, or any other type of network.

Further, while many of the examples above relate to downloading web pages, it should be understood that the concepts may be applied to any content downloaded over a network. For example, text-based documents, photographs, video files, music files, games, and any other type of data may be compressed using the above-described systems and methods.

The above-described subject matter may be advantageous in providing high-quality content over a network while reducing consumption of resources, such as bandwidth. Because less data may be transmitted over the network, network congestion may be relieved. Moreover, because a compressed file is transmitted, download speed may be much quicker than downloading an entire file. This may be particularly beneficial for users that access content frequently, such as every day or several times a day. Moreover, the system is further advantageous in that it keeps itself updated. For example, by continually updating the databases of content and identifiers each time content is received, compression of newly requested content can always be performed in an optimal way by priming the gzip dictionary with the most recent stored content, which often is most similar to the new content.

Although the present disclosure references particular examples, it should be understood that these examples are merely illustrative. Additionally, it should be understood that numerous other modifications may be made to the illustrative examples without departing from the spirit and scope of the subject matter defined by the appended claims.

1. A computer-implemented method, comprising:
identifying content to be retrieved over a network;
determining whether content similar to the identified content is locally available;
if similar content is locally available, transmitting a request for the identified content, wherein the request identifies the locally available similar content;
receiving a compressed file associated with the requested content; and
decompressing, using a processor, the compressed file using the locally available similar content.

2. The method of claim 1, wherein the similar content is a previously retrieved version of the requested content.

3. The method of claim 1, wherein the identified content is a web page.

4. The method of claim 3, wherein the similar content is a different web page from a same web site as the identified content.

5. The method of claim 1, wherein determining whether similar content is locally available comprises determining whether a file having a same domain as the identified content is locally available.

6. The method of claim 1, wherein the compressed file comprises a file in which redundancies between the identified content and the similar content have been removed from the identified content.

7. The method of claim 6, wherein the compressed file comprises a gzipped file.

8. The method of claim 6, wherein decompressing the compressed file comprises reconstructing the identified content using the locally available similar content.

9. The method of claim 8, wherein decompressing the compressed file comprises using gunzip.

10. A device for retrieving requested content, comprising:
a processor;
a memory in communication with the processor, the memory storing:
one or more files of previously downloaded content;
an identifier associated with each of the one or more files of previously downloaded content; and
instructions executable by the processor for downloading requested content according to a method, comprising:
identifying content to be retrieved over a network;
determining whether content similar to the identified content is locally available;
if similar content is locally available, transmitting a request for the identified content, wherein the request identifies the locally available similar content;
receiving a compressed file associated with the requested content; and
decompressing the compressed file using the locally available similar content.

11. The device of claim 10, further comprising a browser for interfacing with a user.

12. The device of claim 11, wherein the browser is an Internet browser.

13. The device of claim 11, wherein the browser is an app.

14. The device of claim 10, wherein the one or more files include content relating to one or more web pages.

15. The device of claim 10, wherein the device is capable of communicating over a network.

16. The device of claim 15, wherein the device is capable of wireless communication.

17. The device of claim 16, wherein the device is one of a mobile phone, tablet computer, portable music player, portable video player, portable video game console, or handheld computer.

18. A method for serving data over a network, comprising:
receiving a request for content;
determining whether the request includes an identifier associated with the content; and
if the request includes an identifier associated with the content:
retrieving the requested content;
compressing, using a processor, the requested content using at least one file corresponding to the identifier; and
transmitting the compressed content.

19. The method of claim 18, further comprising:
assigning a new identifier to the compressed content; and
transmitting the new identifier along with the compressed content.

20. The method of claim 18, wherein if the request does not include an identifier associated with the content, the method further comprises:
retrieving the requested content;
assigning an identifier to the requested content;
storing the content in association with the assigned identifier; and
transmitting the retrieved content and the assigned identifier.

21. The method of claim 18, wherein compressing the requested content comprises:
comparing the retrieved content to the at least one file corresponding to the identifier; and
removing portions of the retrieved content which exist in the at least one file corresponding to the identifier.

22. The method of claim 18, wherein compressing the requested content comprises using gzip.

23. The method of claim 22, wherein compressing the requested content comprises loading the files corresponding to the identifier into a gzip dictionary.

24. A device for serving data over a network, comprising:
a processor;
a compression unit;
a memory in communication with the processor and the compression unit, the memory storing:
at least one file corresponding to previously retrieved content;
an identifier associated with the at least one file; and
instructions executable by the processor for performing a method, the method comprising:
receiving a request for content, the request including a requested content identifier associated with the content;
retrieving the requested content;
compressing, at the compression unit, the requested content using a file corresponding to the requested content identifier; and
transmitting the compressed content.

25. The device of claim 24, wherein the device resides on a mobile carrier network.

26. The device of claim 25, wherein the device intercepts the request for content from a mobile network device, wherein the request is destined for a server.

27. The device of claim 24, wherein the device resides on a server.

28. The device of claim 24, wherein the compression unit implements at least one of gzip; compress; and SDCH.
